(19) United States
(12) Patent Application Publication
(10) Pub. No.: US 2025/0077179 A1
(43) Pub. Date: Mar. 6, 2025

(54) MEMORY DEVICE FOR SUPPORTING MACHINE LEARNING, MEMORY SYSTEM INCLUDING THE SAME, AND METHOD OF OPERATING THE SAME

(71) Applicant: SAMSUNG ELECTRONICS CO., LTD., Suwon-si (KR)

(72) Inventors: Hoyoun KIM, Suwon-si (KR); Jongyoon YOON, Suwon-si (KR)

(73) Assignee: SAMSUNG ELECTRONICS CO., LTD., Suwon-si (KR)

(21) Appl. No.: 18/586,002

(22) Filed: Feb. 23, 2024

(30) Foreign Application Priority Data
Sep. 6, 2023 (KR) 10-2023-0118101

(51) Int. Cl. G06F 5/01; G06F 7/499; G06F 7/50; G06F 7/52

(52) U.S. Cl. CPC G06F 5/01; G06F 7/49947; G06F 7/50; G06F 7/52

(57) ABSTRACT

A memory device for supporting machine learning includes a first cell array configured to store weight data at a first precision or a second precision, a second cell array configured to store loss data at the first precision, a third cell array configured to store gradient data at the first precision, and a computation circuit configured to perform at least one of a multiplying operation, a dividing operation, or a rounding operation corresponding to a scaling factor during mixed-precision training that uses the first precision and the second precision.

### CROSS-REFERENCE TO RELATED APPLICATION

This application claims priority to Korean Patent Application No. 10-2023-0118101, filed on Sep. 6, 2023 in the Korean Intellectual Property Office, the disclosure of which is incorporated herein by reference in its entirety.

### BACKGROUND

Example embodiments of the present disclosure relate to a memory device for supporting machine learning, a memory system including the same, and a method of operating the same.

In learning training, mixed precision training may be used as an optimization technique. This technique may improve training performance on a hardware accelerator by combining 32-bit floating point (float32) computation and 16-bit floating point (float16) computations. The goal of mixed-precision training may be to increase learning speed, reduce memory usage, and maintain performance of a learned model.

### SUMMARY

One or more embodiments of the present disclosure provide a memory device for supporting machine learning, which may improve performance while reducing memory usage, a memory system including the same, and a method of operating the same.

According to an example embodiment of the present disclosure, a memory device for supporting machine learning includes a first cell array configured to store weight data with first precision or second precision; a second cell array configured to store loss data with the first precision; a third cell array configured to store gradient data with the first precision; a computation circuit configured to perform at least one of a multiplying operation, a dividing operation, or a rounding operation corresponding to a scaling factor when mixed-precision training is performed; and a scaling circuit configured to output the scaling factor.

According to an example embodiment of the present disclosure, a memory system includes a memory device configured to support machine learning; and at least one processor configured to control the memory device, wherein the memory device includes a first cell array configured to store weight data with first precision or second precision; a second cell array configured to store loss data with the first precision; a third cell array configured to store gradient data with the first precision; a computation circuit configured to perform at least one of a multiplying operation, a dividing operation, or a rounding operation corresponding to a scaling factor when mixed-precision training is performed; and a scaling circuit configured to output the scaling factor.

According to an example embodiment of the present disclosure, a method of operating a memory system including a memory device and a processor includes performing an addition operation having scaling between weight data and gradient data in the memory device when performing mixed precision training; updating the weight data; and changing precision of the updated weight data using a rounding logic.

According to an example embodiment of the present disclosure, a memory system includes at least one memory device configured to support machine learning; an auxiliary memory module configured to perform at least one of a multiplying operation, a dividing operation, or a rounding operation corresponding to a scaling factor when mixed precision training is performed; and a processor configured to control the at least one memory device and the auxiliary memory module, wherein the at least one memory device includes a first cell array configured to store weight data having first precision or second precision; a second cell array configured to store loss data having the first precision; and a third cell array configured to store gradient data having the first precision.

### BRIEF DESCRIPTION OF DRAWINGS

The above and/or other aspects will be more apparent by describing certain example embodiments, with reference to the accompanying drawings, in which:

FIG. 1 is a diagram illustrating a process and a structure for performing mixed precision training according to an embodiment of the present disclosure;

FIG. 2 is a diagram illustrating an operation of mixed precision training according to an embodiment of the present disclosure;

FIG. 3 is a diagram illustrating loss scaling of mixed precision training according to an embodiment of the present disclosure;

FIG. 4 is a diagram illustrating a memory system according to an example embodiment of the present disclosure;

FIG. 5 is a diagram illustrating in-memory floating point precision conversion according to an example embodiment of the present disclosure;

FIG. 6 is a diagram illustrating a weight updating operation in a memory device according to an example embodiment of the present disclosure;

FIG. 7 is a diagram illustrating a memory system according to another example embodiment of the present disclosure;

FIG. 8 is a flowchart illustrating a mixed precision training operation of a memory device according to an example embodiment of the present disclosure;

FIG. 9 is a diagram illustrating a neural network learning device according to an example embodiment of the present disclosure;

FIG. 10 is a diagram illustrating a computation device according to an example embodiment of the present disclosure; and

FIG. 11 is a diagram illustrating an electronic device according to an example embodiment of the present disclosure.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

While such terms as “first,” “second,” etc., may be used to describe various elements, such elements must not be limited to the above terms. The above terms may be used only to distinguish one element from another.

When two elements are presented with a slash (/) between them—such as element1/element2—it should be interpreted as indicating the involvement of either one of the elements (either element 1 or element 2) or both elements (both element 1 and element 2).

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

A memory device for supporting or facilitating machine learning, a memory system including the same, and a method of operating the same according to an example embodiment may process machine learning data in the memory device. In example embodiments, the memory device may be implemented as a memory module in which Processing in Memory (PIM) or Processing New Memory (PNM) uses multiply, divide, or round logic. The memory device may include a module that operates as a memory expander having data computation capabilities. In an example embodiment, using the memory device for supporting machine learning, the memory system including the same, and the method of operating the same, may lead to enhanced bandwidth, reduced delay, and increased power gain due to reduced redundant data transactions. In example embodiments, a precision change operation for mixed precision training may be performed on in the memory device.

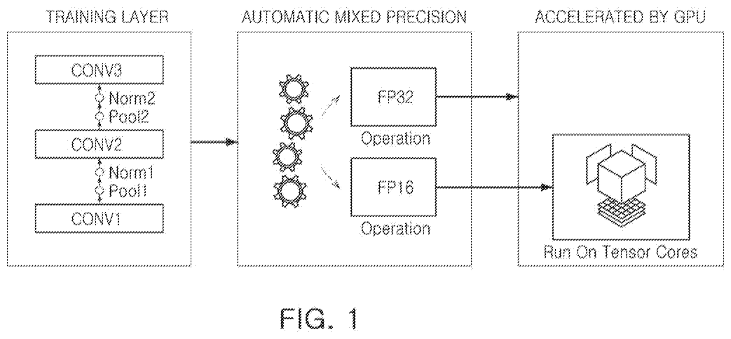

FIG. 1 is a diagram illustrating a process and a structure for performing mixed precision training according to embodiments. A processor may not need to individually change or adjust precision of all data sent to the memory. A task of adjusting the precision may be performed in the memory. Accordingly, performing precision changes in the memory devices may contribute to system load-balancing.

Mixed precision training may involve using different levels of numerical precision (e.g., a lower numerical precision format such 16-bit floating-point numbers (float16), and a higher numerical precision format such as 32-bit floating-point numbers (float32)) for computations during the training process. In the mixed precision training, certain parts of the training may use lower precision to speed up computations and reduce memory usage, while other parts of the computation use higher precision to maintain accuracy. Mixed precision training may be advantageous because the fast speed of float16 can be used for certain computations while retaining the numerical stability of float32 when needed, especially in parts of a neural network where higher precision is crucial to prevent overflow or underflow issues. Float16 computation may use less memory than float32 computation, allowing for larger model training or larger mini-batch sizes in the same graphics processing unit (GPU) memory. A GPU architecture may process float16 computation faster than float32 computation, leading to increased learning speed. However, the limited numerical range of float16 computation may lead to overflow or underflow in some computations. Hardware such as tensor core may alleviate the above issue. To prevent overflow or underflow issues, it might be necessary to avoid considering relatively small gradient values as zero (0) in float16. To this end, a loss value may be scaled up at a predetermined rate. After performing backpropagation using this scaled loss, gradients may be scaled down to an original rate again before updating. By maintaining a float32 copy of weights, gradient update may be performed more precisely, and issues arising from float16 precision limitations may be mitigated.

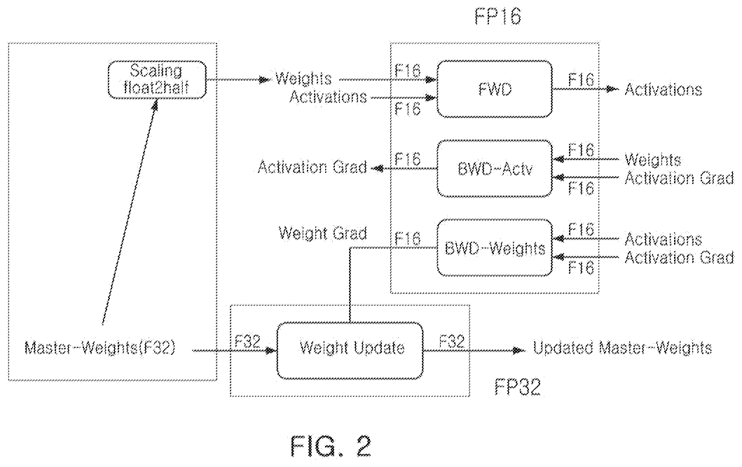

FIG. 2 is a diagram illustrating operation of mixed precision training according to embodiments. Referring to FIG. 2, mixed precision training may include a process of replicating a master weight for each learning cycle, which may lead to memory wastage. In an example embodiment, the memory waste issue is addressed by implementing precision mixing within the memory.

A memory device according to an example embodiment may support mixed precision training in the memory when a machine learning system performs a learning process. In particular, by changing precision of input and output data of the memory, unnecessary neural network data replication process may be eliminated or mitigated.

The training of neural networks may affect computation, power consumption, and memory usage, especially regarding floating point precision. In mixed precision training, transitioning from 32-bit precision (single precision) to 16-bit precision (half precision) may involve or require updating data with 32-bit precision, but data used and lost in training iteration may operate with the lower precision (i.e., 16-bit precision).

When shifting from 32-bit precision (FP32) to 16-bit precision (FP16), representations in 32-bit precision (FP32) may not be necessarily represented in 16-bit precision (FP16). By loss scaling (e.g., data range shift or exponent change) for values changed (e.g., forced conversion to 0) in data with 32-bit precision, the data may be used in training. De-scaling during the master weight update in the memory, may reduce data distortion and may facilitate weight updates.

In the mixed precision training, after converting a master weight from FP32 to FP16, forward/back-propagation may be computed with FP16. In this case, when updating the weight from a computed gradient (gradient (FP16)), the master weight may undergo conversion back to FP32 for the update process.

Using FP16 as-is may lead to an increase in the training loss, impeding proper learning. In order to address this issue, a loss scaling technique may be used.

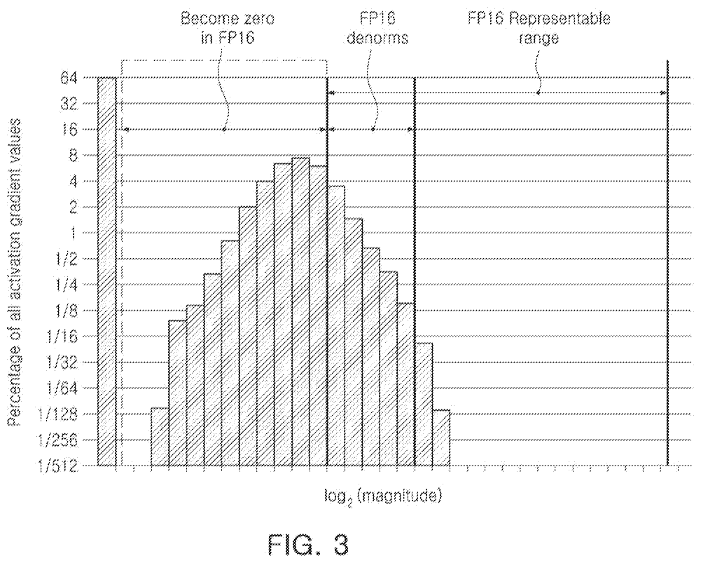

FIG. 3 is a diagram illustrating loss scaling of general mixed precision training according to embodiments. In FIG. 3, a histogram of activation gradient values is illustrated. As training diverges, loss scaling may be necessary. As illustrated in FIG. 3, when a gradient is computed with FP16, FP16 may not accurately represent the gradient when the gradient is relatively small. Loss scaling may be applied to shift the gradient into a range representable by FP16 to prevent errors caused by a “0” portion. For example, to shift the gradient to a range represented by FP16, the gradient may be multiplied by a scaling factor S.

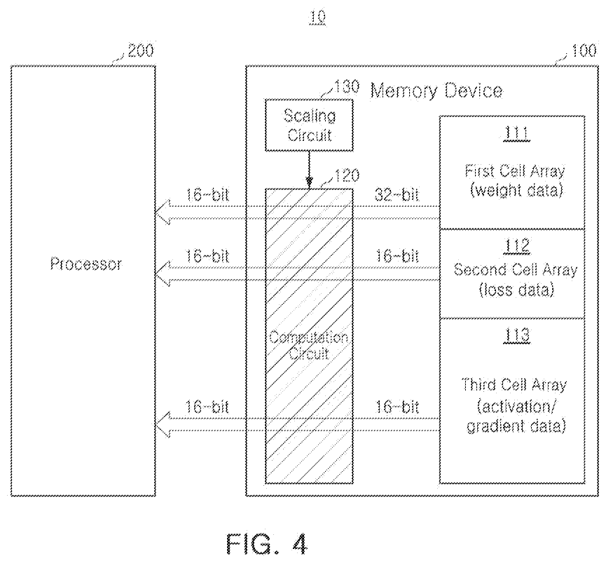

FIG. 4 is a diagram illustrating a memory system according to an example embodiment. Referring to FIG. 4, the memory system 10 may include a memory device 100 configured to support machine learning and a processor 200 configured to control the memory device 100. For example, the processor 200 may be implemented as a neural processing unit (NPU), central processing unit (CPU), graphic processing unit (GPU), or data processing unit (DPU).

The memory device 100 may include at least one volatile memory device or at least one non-volatile memory device for performing machine learning. In an example embodiment, the volatile memory device may be implemented as a dynamic random access memory (DRAM), a static random access memory (SRAM), a thyristor RAM (T-RAM), a zero capacitor RAM (Z-RAM), or a twin transistor RAM (TTRAM). In an example embodiment, a non-volatile memory device may be implemented as an electrically erasable programmable read-only memory (EEPROM), flash memory, magnetic RAM (MRAM), spin-transfer torque (STT)-MRAM, conductive bridging RAM (CBRAM), ferroelectric RAM (FeRAM), PRAM (Phase change RAM), resistive memory (Resistive RAM (RRAM)), nanotube RRAM (Nanotube RRAM), polymer RAM (PoRAM), nano floating gate memory (NFGM), holographic memory, molecular electronic memory device, or insulator resistance change memory.

The memory device 100 may be implemented to support mixed precision. Here, mixed precision may include 16-bit precision (also referred to as “first precision”) and 32-bit precision (also referred to as “second precision”). In an example embodiment, the mixed precision is not limited thereto. The training precision may allow for variations such as any combination of 32, 64, or 128-bit precision. In the description below, for ease of description, data transmitted from memory device 100 to the processor 200 may have 16-bit precision, and data transmitted from the processor 200 to the memory device 100 may have 16-bit or 32-bit precision.

The memory device 100 may include a first cell array 111, a second cell array 112, a third cell array 113, a computation circuit 120, and a scaling circuit 130. Although FIG. 4 illustrates the scaling circuit 130 separately from the computation circuit, embodiments are not limited thereto, and the scaling circuit 130 may be incorporated into the computation circuit 120.

The first cell array 111, the second cell array 112, and the third cell array 113 may be logically or physically divided. In an example embodiment, each of the first cell array 111, the second cell array 112, and the third cell array 113 may be divided according to class of data used for machine learning.

In an example embodiment, the first cell array 111 may store weight data. Weight data may have different precisions such as in-memory precision and out-memory precision. This variance may lead to weight data having mixed precision.

The second cell array 112 may store loss data. The loss data of the second cell array 112 may be multiplied by a scaling factor and may be inputted to and/or outputted from the second cell array 112 through a memory-in operation and/or a memory-out operation. The multiplication operation may occur only once during memory-in/memory-out, and therefore computation time gain may be relatively large. Here, multiplication computation may be performed in a memory-in/memory-out process.

The third cell array 113 may store activation/gradient data. Activation/gradient data of the third cell array 113 may undergo memory-in/memory-out processes after being divided by the scaling factor. The division operation may be performed only once during memory-in/memory-out, and therefore the computation time gain may be relatively large. Here, division computation may be performed during memory-in/memory-out.

The scaling circuit 130 may be implemented to output a scaling factor indicating precision. The scaling factor may start from an initial value (e.g., 23) and may be reduced and used when data overflow occurs during processor computation of the computation circuit 120, which may indicate that processor driven tuning may be performed. The processor 200 may control the computation circuit 120 through alert/exception signaling of the memory device 100.

The memory device 100 may support mixed precision training using the scaling factor output by the scaling circuit 130 and the Processing In the memory (PIM) computation (e.g., multiplying, dividing, rounding, or the like) of the computation circuit 120.

Mixed precision training of memory device 100 according to an example embodiment may perform computation at the half-precision training level and may increase training speed and resource efficiency by using memory. Also, mixed precision training of the memory device 100 according to an example embodiment may have single-precision training level results as inference results (or, neural network performance).

In a conventional memory system, mixed precision training may be performed by converting precision under the control of the processor of the system, such that unnecessary neural network data replication process may be led in the memory device. The memory system 10 according to an example embodiment may eliminate or reduce unnecessary neural network data replication processes by converting precision of in-data/out-data in the memory.

In an example embodiment, the memory system 10 may support precision conversion in the memory by performing artificial intelligence (AI) mixed precision training. Accordingly, the memory system 10 may improve an effective bandwidth of memory. In other words, an effective bandwidth of the memory may be increased due to a decrease in precision of data exchanged between the processor and the memory.

In example embodiments, a memory device/memory module may support machine learning. Mixing of data precision may be performed in the memory device/memory module. In an example embodiment, the memory device/memory module may inform the system (a processor) of the result of dividing the memory cell array. For example, the memory device/memory module may inform the system or the processor that the memory cell array are divided into a first memory cell, a second memory cell, and a third memory cell which are allocated to store weight data, loss data, and gradient data (and/or activation data), respectively. In an example embodiment, input data (memory-in data) may be divided into data classes and stored in a memory device. In an example embodiment, memory-out data may be divided according to data class and may be transmitted to the system through a memory module implementing rounding logic (PIM)/processing near memory (PNM). In an example embodiment, weight data may be updated during training. In an example embodiment, in the memory, addition with scaling between weight data and gradient data may be performed. In an example embodiment, precision of updated weight data may be converted using a rounding logic such as a memory module in which PIM/PNM is implemented, the weight data may be transmitted to the system.

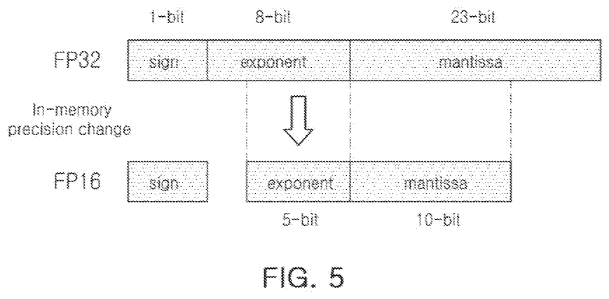

FIG. 5 is a diagram illustrating in-memory floating point precision conversion according to an example embodiment. Referring to FIGS. 4 and 5, the computation circuit 120 may be configured in the form of an internal PIM memory. Floating point precision conversion may be performed as illustrated in FIG. 5. When performing floating point FP format conversion from FP32 into FP16, a length of the data may be reduced by reducing the exponent and rounding a mantissa to the nearest. Rounding logic configured to perform the conversion operation may be implemented using a PIM.

The in-memory precision mixing may reduce memory usage/occupancy by deleting unnecessary data replication processes during mixed precision training. By reducing precision of memory-to-processor data through the PIM, efficient memory bandwidth may be increased.

In an example embodiment, floating point conversion is not limited to the conversion from FP32 into FP16, and various floating point format conversion may be supported.

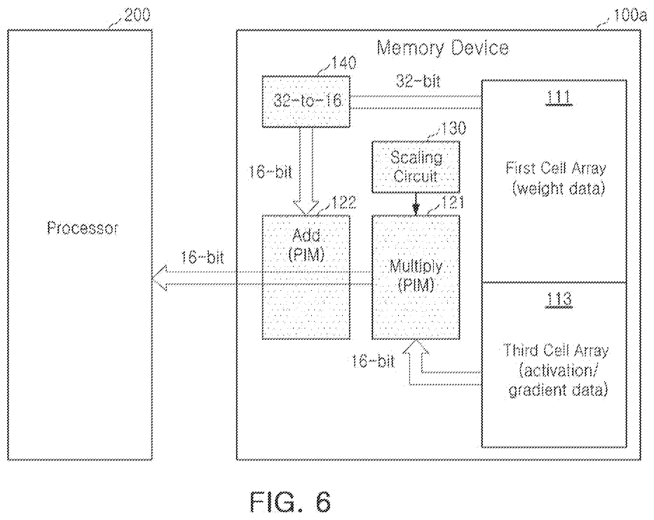

FIG. 6 is a diagram illustrating a weight updating operation in a memory device according to an example embodiment. When a training cycle ends, a weight updating operation may be necessary. Referring to FIG. 6, off-loading may be performed in the memory device 100a in a weight updating operation process using a PIM (including a multiplication logic and/or an addition logic).

The memory cell array may include the first cell array 111 configured to store weight data, and the third cell array 113 configured to store gradient data. The first cell array 111 may output the weight data at FP32 precision and the third cell array 113 may output gradient data at FP16 precision. The gradient data may be transmitted to a multiplication logic 121, which multiplies the gradient data by a scaling factor received from the scaling circuit 130 to obtain scaled gradient data. The weight data may be transmitted to a floating point conversion circuit 140, which performs floating point conversion on the weight data to convert the precision of the weight data from FP32 to FP16, so that the precision of the weight data matches the FP16 precision of the gradient data. After precision matching, the precision-converted weight data may be transmitted to an addition logic 122, and the addition logic 122 may add the precision-converted weight and the scaled gradient data. The multiplication logic 121, the addition logic 122, and the floating point conversion circuit 140 may be included in the computation circuit 120 illustrated in FIG. 4. Also, the scaling circuit 130 may be included in the computation circuit 120.

In example embodiments, the weight updating operation process may ensure effective off-loading by the processor.

In example embodiments, the example embodiment may be applied to a memory module.

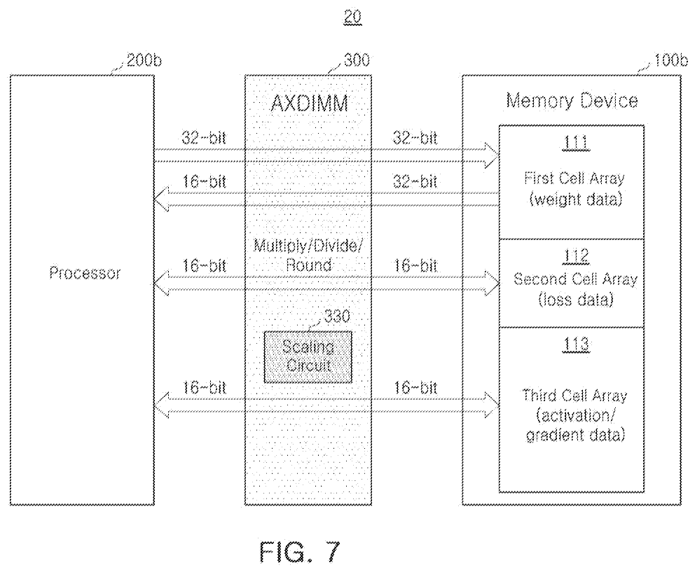

FIG. 7 is a diagram illustrating a memory system according to another example embodiment. Referring to FIG. 7, the memory system 20 may include at least one memory device 100b, a processor 200b and an auxiliary memory module 300 (AXDIMM). Here, at least one memory device 100b and auxiliary memory module 300 may be implemented as a memory module.

At least one memory device 100b may be implemented to support machine learning. The memory device 100b may include a first cell array 111 configured to store weight data, a second cell array 112 configured to store loss data, and a third cell array 113 configured to store activation/gradient data. Here, weight data may have first precision or second precision, and loss data and activation/gradient data may have first precision.

The auxiliary memory module 300 (AXDIMM) may be implemented to perform at least one of multiplying operation, a dividing operation, or a rounding operation corresponding to a scaling factor when performing mixed precision training. The auxiliary memory module 300 may be implemented as a process-in-module (e.g., AXDIMM, or the like) configured to perform mixed precision training described in FIGS. 4 to 7. That is, the auxiliary memory module 300 may perform the same or similar mixed precision training operation in the memory described in FIGS. 4 to 7.

In an example embodiment, the auxiliary memory module 300 may include a scaling circuit 330 configured to output a scaling factor. In an example embodiment, the auxiliary memory module 300 may receive second precision weight data from the processor 200b and may store the second precision weight data in the first cell array 111 of the memory device 100b. In an example embodiment, the auxiliary memory module 300 may receive second precision weight data from the first cell array 111 of the memory device 100b, may convert the second precision weight data into first precision weight data, and may output weight data of the first precision to the processor.

The processor 200b may be implemented to control at least one memory device 100b and the auxiliary memory module 300.

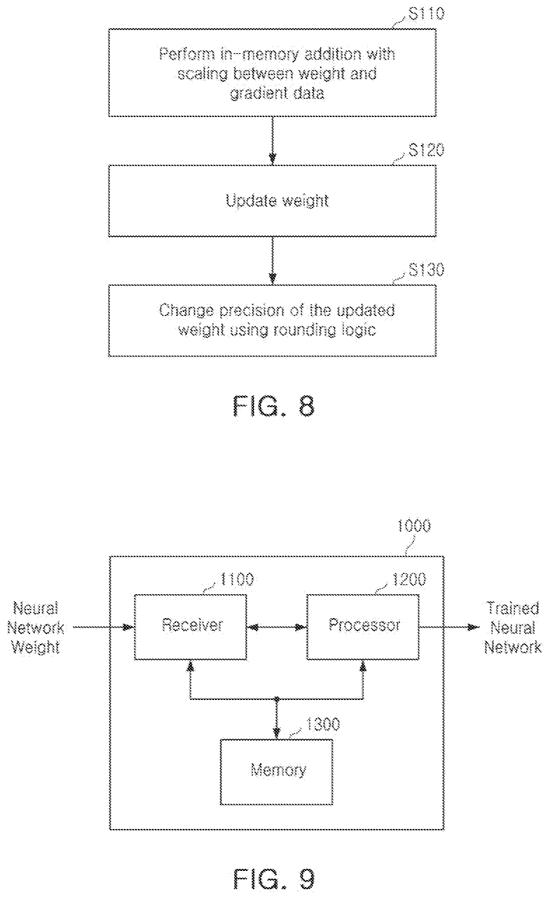

FIG. 8 is a flowchart illustrating a mixed precision training operation of a memory/module according to an example embodiment. Referring to FIGS. 1 to 8, the mixed precision training operation may be performed as below.

In-memory addition with scaling may be performed between weight data and gradient data (S110). Weight data may be updated using a memory module in which rounding PIM/PNM is implemented (S120). Precision of updated weight data may be changed, for example, using a rounding logic (S130). In an example embodiment, weight data having changed precision may be output to the processor. In an example embodiment, when overflow occurs in mixed precision training, the processor may control the memory device to change the scaling factor. In an example embodiment, the memory device may inform the processor of the result of dividing the memory cell array. For example, the memory device may inform the processor that the memory cell array are divided into at least three memory cells, including a first memory cell configured to store weight data, a second memory cell configured to store loss data, and a third memory cell configured to store activation and/or gradient data. In an example embodiment, input data of the processor may be stored in a corresponding cell array of the memory device according to the data class, and output data of the memory device may be transmitted to the processor according to the data class.

In-memory mixed precision training according to an example embodiment may be combined with memory module technology in which machine learning-dedicated memory and PIM and PNM may be implemented. In particular, in an example embodiment, in-memory mixed precision training may be used as an AI-oriented memory feature to support machine learning application.

In example embodiments, the example embodiments may be applied to a neural network learning device.

FIG. 9 is a diagram illustrating a neural network learning device (e.g., an electronic device) according to an example embodiment. Referring to FIG. 9, the neural network learning device 1000 may train a neural network (or a neural network model). Also, the neural network learning device 1000 may perform inference using a learned neural network. The neural network learning device 1000 may train neural networks with low computation complexity. The neural network learning device 1000 may reduce complexity of neural network computation by learning a neural network using quantization.

In an example embodiment, the neural network may include a deep neural network. The neural network may include convolutional neural network (CNN), recurrent neural network (RNN), perceptron, multilayer perceptron, feed forward (FF), radial basis network (RBF), deep feed forward (DFF), long short term memory (LSTM), gated recurrent unit (GRU), auto encoder (AE), variational auto encoder (VAE), denoising auto encoder (DAE), sparse auto encoder (SAE), Markov chain (MC), Hopfield network (HN), Boltzmann machine (BM), restricted Boltzmann machine (RBM), Depp belief network (DBN), deep convolutional network (DCN), deconvolutional network (DN), deep convolutional inverse graphics network (DCIGN), generative adversarial network (GAN), liquid state machine (LSM), extreme learning machine (ELM), echo state network (ESN), deep residual network (DRN), differential neural computer (DNC), neural turning machine (NTM), capsule network (CN), Kohonen network (KN) and attention network (AN).

In an example embodiment, the neural network learning device 1000 may be implemented on an embedded system using a limited hardware resource using a lightweight neural network model. The neural network learning device 1000 may perform both learning and inference on-device. The neural network learning device 1000 may be implemented as a printed circuit board (PCB) such as a motherboard, an integrated circuit (IC), or a system on chip (SoC). For example, the neural network learning device 1000 may be implemented as an application processor.

Also, the neural network learning device 1000 may be implemented in a personal computer (PC), a data server, or a portable device. The portable device may include a laptop computer, a shift phone, a smartphone, a tablet PC, a mobile internet device (MID), a personal digital assistant (PDA), and an enterprise digital assistant (EDA), a digital still camera, a digital video camera, portable multimedia player (PMP), personal navigation device or portable navigation device (PND), a handheld game console, an e-book or a smart device. A smart device may be implemented as a smartwatch, a smart band, or a smart ring.

In an example embodiment, the neural network learning device 1000 may learn a neural network by processing a weight of the neural network model. The neural network learning device 1000 may generate a lightweight neural network model by processing a weight of the learned neural network model with full precision. The neural network learning device 1000 may obtain new weight by processing weight which changes during learning of the neural network model and may retrain the neural network model on the basis of the new weight.

Referring again to FIG. 9, the neural network learning device 1000 may include a receiver 1100, a processor 1200, and a memory device 1300. Here, the memory device 1300 may be implemented to support machine learning as described in FIGS. 1 to 8.

The receiver 1100 may include a receiving interface. The receiver 1100 may receive a neural network model or parameters corresponding to a neural network model. For example, the receiver 1100 may receive weight of a neural network model. The receiver 1100 may receive a randomly initialized neural network model or a learned neural network model on the basis of random weight. For example, the receiver 1100 may receive a first learned neural network model on the basis of first weight. In this case, the first weight may include a quantized weight. The receiver 1100 may output a received neural network model or parameters corresponding to the neural network model to the processor 1200.

The processor 1200 may be implemented to process data stored in the memory device 1300. The processor 1200 may execute computer-readable code (e.g., software) stored in the memory device 1300 and instructions triggered by the processor 1200.

The processor 1200 may be configured as a data processing device implemented as hardware having a circuit having a physical structure for executing desired operations. For example, the desired operations may include code or instructions included in a program. For example, the data processing device implemented in hardware may include a microprocessor, a central processing device, a processor core, a multi-core processor, and a multiprocessor, application-specific integrated circuit (ASIC), field programmable gate array (FPGA).

In an example embodiment, the processor 1200 may obtain the plurality of second weight from the second learned neural network model by second learning the first learned neural network model on the basis of the plurality of learning rate. The processor 1200 may perform second learning of a first learned neural network model on the basis of the plurality of learning rate. The processor 1200 may perform second learning of a first learned neural network model on the basis of a cyclical learning rate. In this case, the cyclical learning rate may refer to a learning rate changing according to the cycle of a predetermined epoch. The cyclical learning rate may change linearly or nonlinearly in a cycle.

Also, the processor 1200 may obtain the plurality of second weights from the second learned neural network model on the basis of the plurality of learning rate. The processor 1200 may obtain the plurality of second weights from the second learned neural network model on the basis of the lowest learning rate among the plurality of learning rates. For example, the processor 1200 may obtain the plurality of second weight from the second learned neural network model on the basis of the lowest learning rate in a cycle of the cyclical learning rate.

The processor 1200 may perform third learning of the second learned neural network model on the basis of the plurality of second weight. In other words, the second learning and the third learning may refer to retraining of a neural network. The processor 1200 may obtain an average value of the plurality of second weights. The processor 1200 may obtain an average shift value of the plurality of second weights. The processor 1200 may obtain a quantized average value by quantizing the average value. The processor 1200 may perform third learning of the second learned neural network model on the basis of the quantized average value.

The processor 1200 may perform third learning of the second learned neural network model with an epoch less than a predetermined epoch on the basis of a learning rate smaller than a maximum value of the plurality of learning rate.

The memory device 1300 may store a neural network model or parameters of a neural network model. The memory device 1300 may store instructions (or programs) executable by a processor. For example, instructions may include instructions for executing operations of the processor and/or operations of each component of the processor. In an example embodiment, the memory device 1300 may be implemented as a volatile memory device or a non-volatile memory device.

The example embodiments may be applied to a computation device configured to perform tensor computation. Generally, a tensor may have a multidimensional array, and tensor computation may refer to computation between tensors. In deep learning, tensor computations such as element-wise computation, matrix multiplication, tensor reshaping, axis-wise computation (reduction along an axis), tensor concatenation & splitting, or the like. Among these tensor computations, mixed precision training operations may be performed.

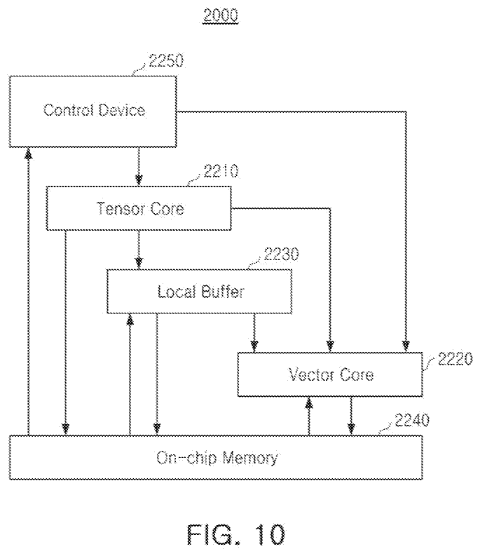

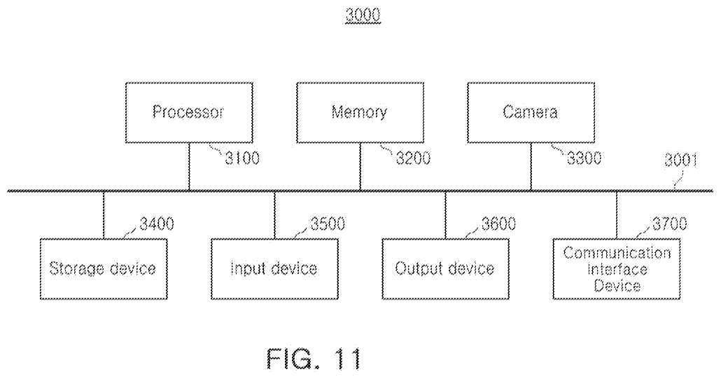

FIG. 10 is a diagram illustrating a computation device according to an example embodiment. Referring to FIG. 10, the computation device 2000 may include a tensor core 2210, a vector core 2220, a local buffer 2230, an on-chip memory device 2240 and a control device 2250 configure to fetch instructions from the on-chip memory device 2240 and control the tensor core 2210 and the vector core 2220.

The tensor core 2210 may be configured as an artificial intelligence (AI) accelerator (also referred to as a neural network accelerator) on the basis of an adder tree configured to perform tensor computation. The vector core 2220 may be configured as a MAC-based co-processor configured to perform vector computation. The computation device 2000 may include an adder tree-based neural network accelerator and a MAC-based co-processor, may perform tensor computation in the adder tree-based neural network accelerator and may efficiently perform vector computation in the MAC-based co-processor. When vector computation using an output of tensor computation as an input is performed, vector computation may be performed without write-back on the on-chip memory device 2240 using the output of tensor computation as the input of vector computation, rather than performing vector computation after writing back the output of tensor computation to the on-chip memory device 2240. Accordingly, the computation device 2000 may reduce the memory bandwidth requirements of vector computation and may improve computation resource utilization.

Also, the on-chip memory device 2240 may be implemented to perform mixed precision training as described in FIGS. 1 to 8 during tensor computation operation. In this case, most computations in tensor computation may be performed with second precision (e.g., float32), but a portion of computation may be performed with first precision (float16). In an example embodiment, important computations (e.g., weight computation) may be performed with 32-bit precision, but the other computations may be performed with 16-bit precision.

The computation device 2000 may include a local buffer 2230 for data reuse. The data reuse may refer to performing computation by repeatedly using loaded data (e.g., weight or input feature map), and the number of data loads and computations may be reduced through the data reuse.

The example embodiment may be applied to an electronic device.

FIG. 11 is a diagram illustrating an electronic device 3000 according to an example embodiment. Referring to FIG. 11, the electronic device 3000 may include a processor 3100, a memory device 3200, a camera device 3300, a storage device 3400, an input device 3500, an output device 3600, and a communication interface device 3700. The processor 3100, the memory device 3200, the camera device 3300, the storage device 3400, the input device 3500, the output device 3600 and the communication interface device 3700 may communicate with each other through the system bus 3001. For example, the electronic device 3000 may be implemented as a mobile device such as a shift phone, a smartphone, a PDA, a netbook, a tablet computer, a laptop computer, or the like, a wearable device such as smart watch, smart band, smart glasses, or the like, a computing device such as a desktop and server, home appliances such as a television, smart television, refrigerator, or the like, a security device such as a door lock, or at least a portion of a vehicle, such as an autonomous vehicle, a smart vehicle, or the like.

The processor 3100 may execute functions and instructions executed in the electronic device 3000. For example, the processor 3100 may process instructions stored in the memory device 3200 or the storage device 3400.

The memory device 3200 may store data for image processing. The memory device 3200 may include a computer-readable storage medium or a computer-readable storage device. The memory device 3200 may store instructions for execution by the processor 3100 and may store related data while software and/or applications are executed by the electronic device 3000. Also, the memory device 3200 may be implemented to perform mixed precision training in the memory as described in FIGS. 1 to 8.

The camera device 3300 may obtain photos and/or videos. For example, the camera device 3300 may capture a facial image including a user's face. The camera device 3300 may be configured as a 3D camera including depth data about objects. The storage device 3400 may include a computer-readable storage medium or a computer-readable storage device. The storage device 3400 may store a larger amount of data than the memory device 3200 and may store data for a relatively long period of time. For example, the storage device 3400 may include a magnetic hard disk, optical disk, flash memory, floppy disk, or other types of a general non-volatile memory.

The input device 3500 may receive an input from a user through a traditional input method such as keyboard and mouse, and a newly used input method such as touch input, voice input, and image input. For example, the input device 3500 may include a keyboard, a mouse, a touch screen, a microphone, or any other device for detecting input from a user and transmitting the detected input to the electronic device 3000. The output device 3600 may provide an output of the electronic device 3000 to a user through visual, auditory, or tactile channels. The output device 3600 may include, for example, a display, a touch screen, a speaker, a vibration generating device, or any other device for providing output to a user. The communication interface device 3700 may communicate with external devices through a wired or wireless network.

The device described above may be implemented with hardware components, software components, and/or a combination of hardware components and software components. For example, the device and components described in an example embodiment may be implemented using one or more general-purpose or special-purpose computers such as a processor, a controller, an arithmetic logic unit (ALU), a digital signal processor, a microcomputer, a field programmable gate array (FPGA), and a programmable logic unit (PLU), a microprocessor, or any other device which may execute instructions and respond. A processing device may execute an operating system (OS) and one or more software applications running on the operating system. Also, a processing device may access, store, manipulate, process and generate data in response to the execution of software. For ease of description, a single processing device may be used, but the processing device may include a plurality of processing elements or a plurality of types of processing elements. For example, a processing device may include a plurality of processors or a processor and a controller. Also, other processing configurations, such as parallel processors, may be possible.

Software may include a computer program, codes, instructions, or a combination of one or more thereof, and may configure the processing device to operate as desired or to instruct the processing device independently or collectively. Software and/or data may be embodied in any type of machine, component, physical device, virtual equipment, computer storage medium or device to be interpreted by or to provide instructions or data to a processing device. Software may be distributed over networked computer systems and may be stored or executed in a distributed manner. Software and data may be stored on one or more computer-readable recording media.

In example embodiments, when the system performs mixed-precision training for AI, precision conversion may be performed in the memory. Accordingly, the effective bandwidth of the memory may be improved. Generally, a system may mainly perform mixed-precision training through precision conversion. In example embodiments, by converting precision of in/out-data in the memory, unnecessary neural network data replication process may be deleted. Also, in example embodiments, the effective bandwidth of memory may be increased due to a decrease in precision of data exchanged between the processor and the memory. In an example embodiment, data precision conversion may be performed in a memory or a memory module. In an example embodiment, the memory device may inform the system of a result of dividing the memory cell array region. In an example embodiment, a memory device may classify input data according to data class and may store the data in the memory. In an example embodiment, a memory device may classify output data according to data class and transmit the data to the system through a memory module in which rounding logic (PIM)/processing near memory (PNM) is implemented. In an example embodiment, the memory device may perform a weight updating operation in the memory during training. In an example embodiment, the memory device may perform addition with scaling between weight and gradient data in the memory. In example embodiments, the updated weight may be transmitted to the system after precision conversion by utilizing rounding of a memory module in which processing near memory (PIM/PNM) is implemented.

According to the aforementioned example embodiments, the memory device for supporting machine learning, the memory system including the same, and the method of operating the same may convert precision of in-data/out-data in the memory device while performing mixed precision training, thereby efficiently using a memory.

While the example embodiments have been illustrated and described above, it will be configured as apparent to those skilled in the art that modifications and variations could be made without departing from the scope of the present disclosure as defined by the appended claims.

1. A memory device for supporting machine learning, the memory device comprising:
a first cell array configured to store weight data at a first precision or a second precision;
a second cell array configured to store loss data at the first precision;
a third cell array configured to store gradient data at the first precision; and
a computation circuit configured to perform at least one of a multiplying operation, a dividing operation, or a rounding operation corresponding to a scaling factor during mixed-precision training that uses the first precision and the second precision.

2. The memory device of claim 1,
wherein the first precision is a 16-bit precision, and
wherein the second precision is a 32-bit precision.

3. The memory device of claim 1,
wherein the first precision and the second precision are different, and
wherein the second precision is either a 32-bit precision, a 64-bit precision, or a 128-bit precision.

4. The memory device of claim 1, wherein the computation circuit is further configured to convert a data precision from the second precision into the first precision based on the scaling factor.

5. The memory device of claim 1,
wherein the first precision data comprises a 1-bit sign bit, a 5-bit exponent bit, and a 10-bit mantissa bit, and
wherein the second precision data comprises a 1-bit sign bit, a 8-bit exponent bit, and a 23-bit mantissa bit.

6. The memory device of claim 5, wherein the computation circuit is further configured to change the 8-bit exponent bit to the 5-bit exponent bit and change the 23-bit mantissa bit to the 10-bit mantissa bit based on the scaling factor.

7. The memory device of claim 1, wherein the loss data is inputted to or outputted from the second cell array after the multiply operation is performed based on the scaling factor.

8. The memory device of claim 1, wherein the gradient data is inputted to or outputted from a memory comprising the first cell array, the second cell array, and the third cell array after the dividing operation is performed based on the scaling factor.

9. The memory device of claim 1, further comprising a scaling circuit configured to output the scaling factor, and reduce the scaling factor when data overflow occurs in the mixed-precision training.

10. The memory device of claim 1, wherein the first cell array, the second cell array, and the third cell array are physically or logically divided based on class of data used in machine learning.

11. A memory system comprising:
a memory device; and
at least one processor configured to control the memory device,
wherein the memory device comprises:
a first cell array configured to store weight data at first precision or second precision;
a second cell array configured to store loss data at the first precision;
a third cell array configured to store gradient data at the first precision; and
a computation circuit configured to perform at least one of a multiplying operation, a dividing operation, or a rounding operation corresponding to a scaling factor during mixed-precision training that uses the first precision and the second precision.

12. The memory system of claim 11, wherein the at least one processor is further configured to receive notification information about a result of dividing the first cell array, the second cell array, and the third cell array from the memory device.

13. The memory system of claim 11, wherein the memory device is further configured to store input data in one of the first cell array, the second cell array, and the third cell array based on data class of the input data.

14. The memory system of claim 11, wherein the memory device is configured to transmit output data of the memory device to the at least one processor based on data class of the output data through the computation circuit.

15. The memory system of claim 11, wherein the memory device is further configured to update the weight data during the mixed precision training.

16. A method of operating a memory system including a memory device and a processor, the method comprising:
performing an addition operation with scaling between weight data and gradient data in the memory device during mixed precision training;
updating the weight data; and
changing precision of the updated weight data using a rounding logic.

17. The method of claim 16, further comprising:
outputting the weight data having the changed precision to the processor.

18. The method of claim 16, further comprising:
controlling the memory device to change a scaling factor of the scaling in the processor when overflow occurs in the mixed precision training.

19. The method of claim 16, further comprising:
informing the processor of a result of dividing a memory cell array in the memory device.

20. The method of claim 16, further comprising:
storing input data of the processor in a corresponding cell array of the memory device based on data class of the input data; and
transmitting output data of the memory device to the processor based on data class of the output data.

21.-25. (canceled)
